(19) United States
(12) Patent Application Publication
(10) Pub. No.: US 2013/0339510 A1
(43) Pub. Date: Dec. 19, 2013

(54) FAST PROVISIONING SERVICE FOR CLOUD COMPUTING

(71) Applicant: Digital River, Inc, Minnetonka, MN (US)

(72) Inventors: Ryan Patrick DOUGLAS, Edina, MN (US); Lukas John MARTY, Richfield, MN (US); James Robert GRILL, Milton, GA (US); James Edward LEHNHOFF, Eagan, MN (US); Michael Robert WILSON, Savage, MN (US)

(21) Appl. No.: 13/919,695

(22) Filed: Jun. 17, 2013

Related U.S. Application Data
(60) Provisional application No. 61/660,141, filed on Jun. 15, 2012.

(51) Int. Cl. H04L 12/24

(52) U.S. Cl. CPC H04L 41/50
USPC 709/223

(57) ABSTRACT

A cloud-based system and method for provisioning IT infrastructure systems is disclosed. The system and method provided constructs an infrastructure generally comprised of a processing component supplying the computational capacity for a platform element, comprising one or more processing elements, memory and I/O subsystems, a storage component utilizing commodity disk drives and comprised of one or more physical storage devices, and a network component providing a high speed connection among processing elements and the processing component to storage components. In addition, the system and method provide all features required for a complete, immediately usable infrastructure system including registration of IP addresses and domain names so that the user may have the system completely up and running without the aid of an administrator.

### RELATED APPLICATIONS

The present application claims priority under 35 U.S.C. 119(e) of U.S. Provisional Patent Application No. 61/660,141, filed on 15 Jun. 2012 and entitled “Fast Provisioning Service for Cloud Computing.”

### FIELD OF THE INVENTION

The present disclosure relates to distributed computing, services-oriented architecture, and application service provisioning. More particularly, the present disclosure relates to infrastructure-as-a-service provisioning of computer systems for business.

### BACKGROUND OF THE INVENTION

Cloud computing is one of the fastest growing trends in computer technology. Often advertised as the “Cloud,” cloud computing means slightly different things to different people depending on the context. Nevertheless, most definitions suggest that cloud computing is a compelling way to deliver computer services to business organizations, allowing for rapid scale and predictable cost modeling in the deployment and management of applications.

By one definition, cloud computing is a methodology for delivering computational resources to consumers as a single service, rather than as discrete components. Computational resources, such as physical hardware, data storage, network, and software are bundled together in predictable, measurable units and delivered to consumers as complete offerings. Often, these offerings are delivered with tools to help consumers deploy and manage their applications with ease. Applications that best take advantage of cloud computing environments can scale quickly and utilize computing resources easily everywhere the cloud computing environment exists.

Companies that build private cloud computing environments can improve the deployment time for new and growing applications, and at the same time control and better understand the cost of the services provided. Private cloud computing environments are most often built on uniform hardware, utilize virtualization software, and feature monitoring and diagnostic tools to manage and measure usage of the environment.

To better understand this model, consider a project manager asking a company's IT department for a web server for its application. In the traditional model, the project manager would have to provide information about what hardware, disk, geographic location, web server software version, etc. was required specifically for his application. He would wait for various teams to assemble the product by hand and deliver it to him for application deployment.

Public cloud computing environments offered by companies to businesses and individuals offer a complimentary cloud computing model. Amazon Web Services, Microsoft Azure, and Savvis Symphony are examples of such public cloud computing environments. Users consume computing resources and pay for those resources based on a uniform rate plus fees for usage. This utility model, similar to how a power company charges for electricity, is attractive to businesses seeking to operationalize certain IT costs. A savvy IT department may wish to utilize both private and public cloud computing environments to best meet the needs of business.

It traditionally takes weeks to procure and provision computing resources. Project managers, etc. determine their hardware and software requirements, create requisitions to purchase resources, and work with IT organizations to install and implement solutions. Organizations that implement a distributed computing model with a service provisioning solution can streamline this process, control cost, reduce complexity, and reduce time to solution delivery.

Currently, there are three prevailing types of cloud computing service delivery models: infrastructure-as-a-service, platform-as-a-service, and software-as-a-service. Infrastructure-as-a-service is a service delivery model that enables organizations to leverage a uniform, distributed computer environment, including server, network, and storage hardware, in an automated manner. The primary components of infrastructure-as-a-service include the following: distributed computing implementation, utility computing service and billing model, automation of administrative tasks, dynamic scaling, desktop virtualization, policy-based services and network connectivity. This model is used frequently by outsourced hardware service providers. The service provider owns the equipment and is responsible for housing, running, and maintaining the environment. Clients of these service providers pay for resources on a per-use basis. This same model may be leveraged by private organizations that wish to implement the same model for internal business units. Infrastructure-as-a-service is a foundation on which one may implement a more complex platform-as-a-service model, in which the deployment business systems may be modeled and automated on top of infrastructure resources.

An organization may use the cloud computing model to make resources available to its internal clients or external clients. Regardless of how an organization may use the infrastructure, it would be beneficial to have a system and method of deploying resources quickly and efficiently; one where design and delivery are based on performance and security criteria best suited for enterprise needs. One where the developer may merely ask for and receive a web server from IT, with time to delivery, cost of the implementation and the quality of end product predictable and repeatable with costs often lower than a traditionally supplied product. The features of the claimed system and method provide a solution to these needs and other problems, and offer additional significant advantages over the prior art.

### SUMMARY

The present system and methods are related to a computerized system that implements an infrastructure-as-a-service model for a private organization. A private cloud computing platform model and a system and method for the fast provisioning of computing resources are described.

In order to most efficiently deploy cloud services to a company's private users, a fast provisioning system and method allows authorized users to create the environment they require in a minimum amount of time.

Additional advantages and features of the invention will be set forth in part in the description which follows, and in part will become apparent to those skilled in the art upon examination of the following or may be learned by practice of the invention.

### BRIEF DESCRIPTION OF THE DRAWINGS

FIG. 1 illustrates infrastructure-as-a-service architecture arenas.

FIG. 2 illustrates an infrastructure-as-a-service computing platform.

FIG. 3 illustrates a cloud bank deployment model.

FIG. 4 is a conceptual diagram of exemplary cloudbank resources.

FIG. 5 is a schematic cloud comprised of cloud banks.

FIG. 6 is a system virtualization model.

FIG. 7 depicts an Infrastructure-as-a-service communication fabric.

FIG. 8 depicts the logical organization of cloudbank virtual appliances.

FIG. 9 illustrates the cloudbank management VLAN.

FIG. 10 illustrates the global DNS servers for infrastructure-as-a-service name resolution.

FIG. 11a is a sequence diagram illustrating DNS resolution of a global application.

FIG. 11b is a sequence diagram illustrating DNS resolution of a service call via ESB.

FIG. 12a illustrates a single appliance load balancing model for an appliance zone.

FIG. 12b illustrates a multiple appliance load balancing model for an appliance zone.

FIG. 13 illustrates an exemplary component architectural diagram for an embodiment of a fast provisioning system.

FIG. 14 illustrates a Dashboard showing datacenter status for all of the data centers for which a user has access.

FIG. 15 is a screen shot of a “My Resource Pools” screen.

FIG. 16 illustrates resource pool and the virtual machines assigned to the user.

FIG. 17 is a screen shot of a virtual machine information screen.

FIG. 18 is a view of the resources in node-tree form.

FIG. 19 is a screen shot of a “Deploy Virtual machine” window used to select the resource pool for the resource to be deployed.

FIG. 20 is a screen shot of a “My Virtual Machine” screen.

FIG. 21 is a screen shot of a window providing options for selecting environment and role of the new resource.

FIG. 22 is a screen shot of a window providing the user with available chef cook book selections.

FIG. 23 is a screen shot of a window providing the user with available chef role selections.

FIG. 24 is a screen sot of recipes associated with an exemplary role.

FIG. 25 is a screen shot of software version options supported by the company's fast provisioning system.

FIG. 26 is a screen shot of tuning options offered to a user.

FIG. 27 is a screen shot of tuning parameters offered to a user.

FIG. 28 is a screen shot of resource selection parameter confirmation popup window.

FIG. 29 is a screen shot of the “My Virtual Machines” screen during deployment of a new resource.

FIG. 30 is a confirmation message provided when the resource has been successfully deployed.

### DETAILED DESCRIPTION

Listed below are a few of the commonly used terms for the preferred embodiment of the Infrastructure-as-a-service system and method.

### Common Terms and Acronyms

appliance: The term “appliance” refers to virtual appliance that packages an application (application appliance) or a software service (service appliance).

application: An application is a software program that employs the capabilities of a computer directly to a task that a user wishes to perform.

application appliance: An application appliance is a virtual appliance that packages an application.

availability: The availability of a system is the fraction of time that the system is operational.

chef recipes: code scripts required for all installed components.

DASDirect: Attached Storage (DAS) is secondary storage, typically comprised of rotational magnetic disk drives or solid-state disk, which is directly connected to a processor.

DHCP: The Dynamic Host Configuration Protocol (DHCP) as specified by IETF RFC 2131 (Droms, 1997) and IETF RFC 3315 (Drom, Bound, Volz, Lemon, Perkins, & Carney, 2003) automates network-parameter assignment to network devices.

DNS: The Domain Name System (DNS) as specified by numerous RFC standards starting with IETF RFC 1034 (Mockapetris, RFC 1034: Domain Names—Concepts and Facilities, 1987) and IETF RFC 1035 (Mockapetris, 1987) is a hierarchical naming system for computers, services, or any resource connected to the Internet or a private network.

ESB: An enterprise service bus (ESB) is a software architecture construct that provides fundamental services for complex architectures via standards-based messaging-engine (the bus).

HTTP: The Hypertext Transfer Protocol as specified by IETF RFC 2616 (Fielding, et al., 1999).

HTTPS: HTTP over TLS as specified by IETF RFC 2818 (Rescorla, 2000).

IaaS: Infrastructure as a Service (IaaS) is the delivery of computer infrastructure (typically a platform virtualization environment) as a service. Infrastructure as a Service may be implemented either privately or publicly.

IP: The Internet Protocol as specified by IETF RFC 791 (Postel, 1981) or IETF RFC 2460 (Deering & Hinden, 1998).

ISA: An instruction set architecture (ISA) is the part of the computer architecture related to programming, including the native data types, instructions, registers, addressing modes, memory architecture, interrupt and exception handling, and external I/O. An ISA includes a specification of the machine language implemented by a particular processor.

NTP: The Network Time Protocol as specified by IETF RFC 1305 (Mills, 1992) for synchronizing the clocks of computer systems over packet-switched, variable-latency data networks.

processor: The term “processor” refers to the Central Processing Unit (CPU) of a computer system. In most computer systems that would be considered for inclusion within a Infrastructure-as-a-service implementation, the processor is represented by a single integrated circuit (i.e. a “chip”).

RFC: Request for Comments (RFC), a memorandum published by the Internet Engineering Task Force (IETF) describing standards related to the Internet and Internet technologies. Not all RFC's are standards; others may simply describe methods, behaviors, research or innovations applicable to the Internet.

service: A service is a mechanism to enable access to a set of capabilities, where the access is provided using a prescribed interface and is exercised consistent with constraints and policies as specified by the service description (OASIS, 2006). Frequently, the term is used in the sense of a software service that provides a set of capabilities to applications and other services.

service appliance: A service appliance is a virtual appliance that packages a software service.

SLA: Service Level Agreement is a negotiated agreement between a service provider and its customer recording a common understanding about services, priorities, responsibilities, guarantees, and warranties and used to control the use and receipt of computing resources.

SMPA: symmetric multiprocessing architecture (SMPA) is a multiprocessor computer architecture where two or more identical processors can connect to a single shared main memory. In the case of multi-core processors, the SMP architecture applies to the cores, treating them as separate processors.

virtual appliance: A virtual appliance is a software application or service that is packaged in a virtual machine format allowing it to be run within a virtual machine container.

VLAN: A virtual local area network (VLAN) is a group of hosts with a common set of requirements that communicate as if they were attached to the same broadcast domain, regardless of their physical location. A VLAN has the same attributes as a physical LAN, but it allows end stations to be grouped together even if they are not located on the same network switch. VLANs are as specified by IEEE 802.1Q (IEEE, 2006).

Although the disclosure primarily describes the claimed system and method in the terms and context of a private IaaS (private cloud), it is equally applicable to a public cloud made available to external clients, or a configuration and client base that is a combination of the two.

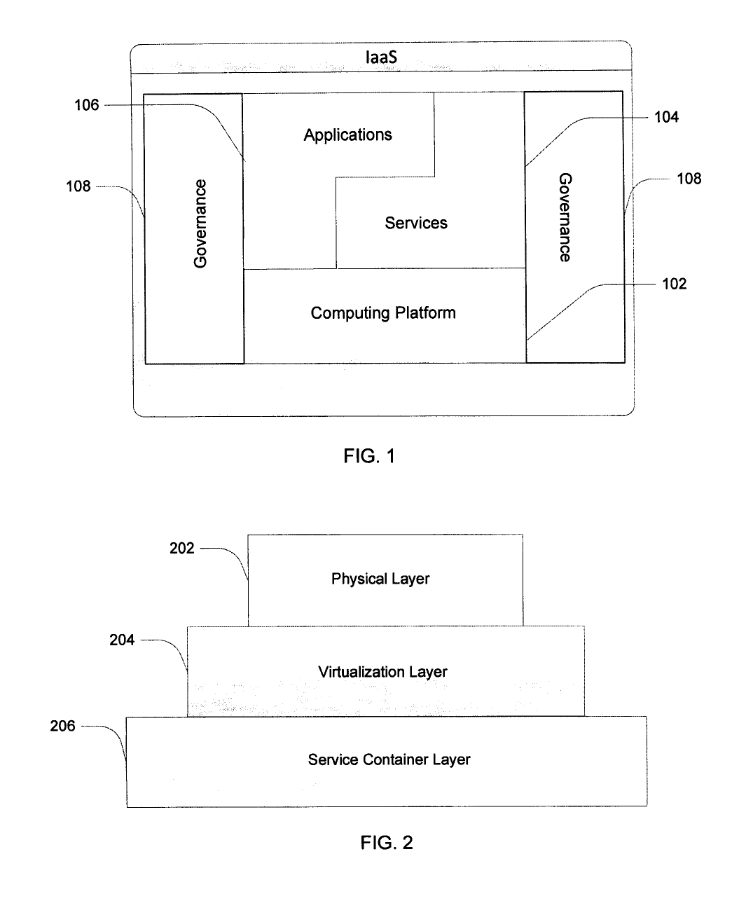

Exemplary Infrastructure-as-a-Service (IaaS) architectural contexts are illustrated in FIG. 1. The system may be comprised of an “elastic” computing platform 102, a portfolio of software services 104 and applications 106, and a governance process 108 to oversee and control the computing platform and the services portfolio. The IaaS platform provides the computational, communication, storage and management infrastructure within which services and applications run. It provides a private “compute cloud” providing IaaS.

Some characteristics of such an exemplary computing platform include: the use of primarily commodity hardware packaged in small units that permit easy horizontal scaling of the infrastructure; the use of virtualization technology to abstract away much of the specifics of hardware topology and provide elastic provisioning; SLA monitoring and enforcement; and resource usage metering supporting chargeback to platform users.

In one exemplary embodiment, computing platform architecture is comprised of a Physical Layer 202, a Virtualization Layer 204, and a Service Container Layer 206, as is illustrated conceptually in FIG. 2. The Physical Layer 202 consists of the hardware resources; the Virtualization Layer 204 consists of software for virtualizing the hardware resources and managing the virtualized resources; and the Service Container Layer 206 consists of a standard configuration of “system services” that provide a container in which application appliances and service appliances run. The computing platform focuses on providing a horizontally scalable infrastructure that is highly available in aggregate but not necessarily highly available at a “component level”.

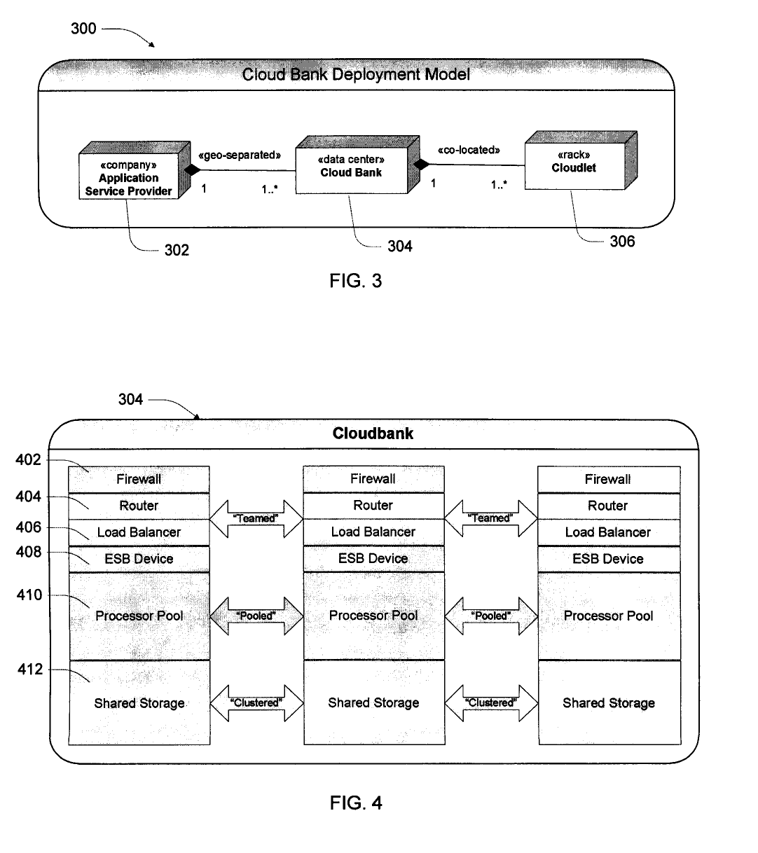

FIG. 3 illustrates a cloud bank deployment model 300. An ecommerce or other network-based service provider 302 maintains a data center with “cloud banks” 304, with a cloudlet 306 being the unit of capacity in the computing platform. A cloudlet 306 is comprised of a standardized configuration of hardware, virtualization and service container components. It is intended that cloudlets 306 can “stand alone” either in a provider's data center or in a co-location facility. Cloudlets 306 are general purpose, not being tuned to the needs of any particular application or service, and are not intended to be highly reliable. Therefore, applications and services whose availability requirements exceed the availability of a cloudlet 306 must “stripe” the application across a sufficient number of cloudlets 306 to meet their needs. Within a cloudlet 306, appliances have low latency, high throughput communication paths to other appliances and storage resources within the cloudlet.

A collection of cloudlets 306 in the same geographical location that collectively provide an “availability zone” is called a cloudbank 304. A cloudbank 304 is sized to offer sufficient availability to a desired quantity of capacity, given a cloudlet 306 lack of high availability. A single data center can and often should contain multiple cloudbanks 304. The cloudbanks 304 within a data center should not share common resources, like power and internet (extra-cloudbank) connectivity, so that they can be taken offline independently of one another.

Cloudlets 306 represent units of “standard capacity” containing storage, processing and networking hardware, coupled with virtualization layer. When aggregating cloudlets 306 into cloudbanks 304, the network resources (firewalls, routers, load balancers, and enterprise service bus (ESB) devices) are typically “teamed,” storage elements clustered and processor elements “pooled” to increase the capacity of the resources being virtualized.

FIG. 4 is a conceptual diagram of exemplary cloudbank 304 resources. Components include firewall 402, router 404, load balancer 406, ESB device 408, processor pools 410 and shared storage clusters 412. Routers 404 and load balancers 406 are teamed across all cloudlets 106 in the cloudbank 104. The processor 410 elements are “pooled” to increase the capacity of the resources being virtualized.

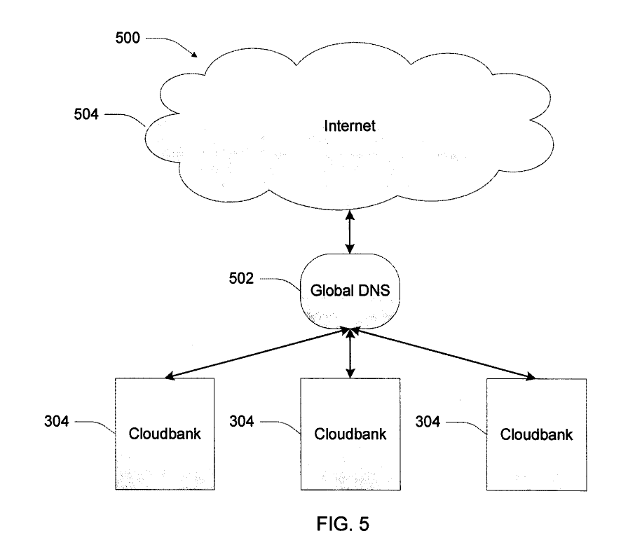

FIG. 5 is a schematic cloud 500 comprised of cloudbanks 304. External to the cloudbanks is some form of “intelligent DNS” 502; in other words, a DNS server that utilizes some form of network topology-aware load-balancing to minimize the network distance between a client and a cloudbank resident resource. In addition, it utilizes some awareness of the availability of a cloudbank resource to avoid giving a client the address of a “dead” resource. This can be referred to as a private cloud “global DNS” server. Communications are made over a network, such as the internet 504.

As will be discussed further below, applications and services are packaged as appliances using one of the virtual machine formats supported by the computing platform. Appliances will package an operating system image and the virtualization layer should support a variety of operating systems, thereby allowing the appliance designer wide latitude to select the operating system most appropriate for the appliance.

Appliances that are well designed for the IaaS may use distributed computing techniques to provide high aggregate availability. Further, well-designed appliances may support cloning, thereby allowing the computing platform to dynamically provision new appliance instances. While the platform is providing a general-purpose computing platform that is not optimized for any specific service or application there are some workload characteristics that are prevalent. Specifically, workloads tend to favor integer performance over floating point performance and single thread performance over multi-threaded performance. Workloads tend to be memory intensive as opposed to CPU intensive. They are often I/O bound, primarily trying to access slow (external) network connections for slow mass storage (disk, often via a database system). Certain workloads (such as distributed file systems) will benefit greatly from having Direct Access Storage (DAS).

### Physical Layer

Referring again to FIG. 3, the basic component of the Physical Layer 202 of Infrastructure-as-a-service is the cloudlet 306. A cloudlet 306 is comprised of a collection of processing, storage, ESB and networking components or elements. Cloudlet 306 components are based upon, for the most part, general-purpose commodity parts.

Processing elements supply the computational capacity for the cloudlet 306. They are typically “blade” or “pizza box” SMP systems with some amount of local disk storage. Processing elements in Infrastructure-as-a-service utilize a “commodity” processor design whose ISA is widely supported by different software technology “stacks” and for which many vendors build and market systems. A processing element generally consists of one or more processors, memory and I/O subsystems.

Each cloudlet 306 has one storage element that provides a pool of shared disk storage.

Storage elements utilize commodity disk drives to drive down the cost of mass storage. A storage element (singular) may be comprised of multiple physical storage devices. Processing elements are connected to one another and to storage elements by a high speed network element. A network element (singular) may be comprised of multiple physical network devices.

Cloudlets 306 are combined together into cloudbanks 304. Cloudbanks 304 provide both capacity scale out, as well as reliability improvement. Some resources, like power and internet connectivity are expected to be shared by all cloudlets 306 in a cloudbank 304, but not be shared by different cloudbanks 304. This means that high availability (four nines or more) is obtained by spreading workload across cloudbanks 304, not cloudlets 306.

### Virtualization Layer

The Virtualization Layer 204 of Infrastructure-as-a-service abstracts away the details of the Physical Layer 202 providing a container in which service and application appliances, represented as system virtual machines, are run. The Virtualization Layer 204 consists of three parts: system virtualization, storage virtualization, and network virtualization.

System virtualization is provided by a software layer that runs system virtual machines (sometimes called hardware virtual machines), which provide a complete system platform that supports the execution of a complete operating system, allowing the sharing of the underlying physical machine resources between different virtual machines, each running its own operating system. The software layer providing the virtualization is called a virtual machine monitor or hypervisor. A hypervisor can run on bare hardware (so called, Type 1 or native VM) or on top of an operating system (so called, Type 2 or hosted VM). There are many benefits to system virtualization. A few notable benefits include the ability for multiple OS environments to coexist on the same processing element, in strong isolation from each other; improved administrative control and scheduling of resources; “intelligent” placement of and improved “load balancing” of a workload within the infrastructure; improved ease of application provisioning and maintenance; and high availability and improved disaster recovery.

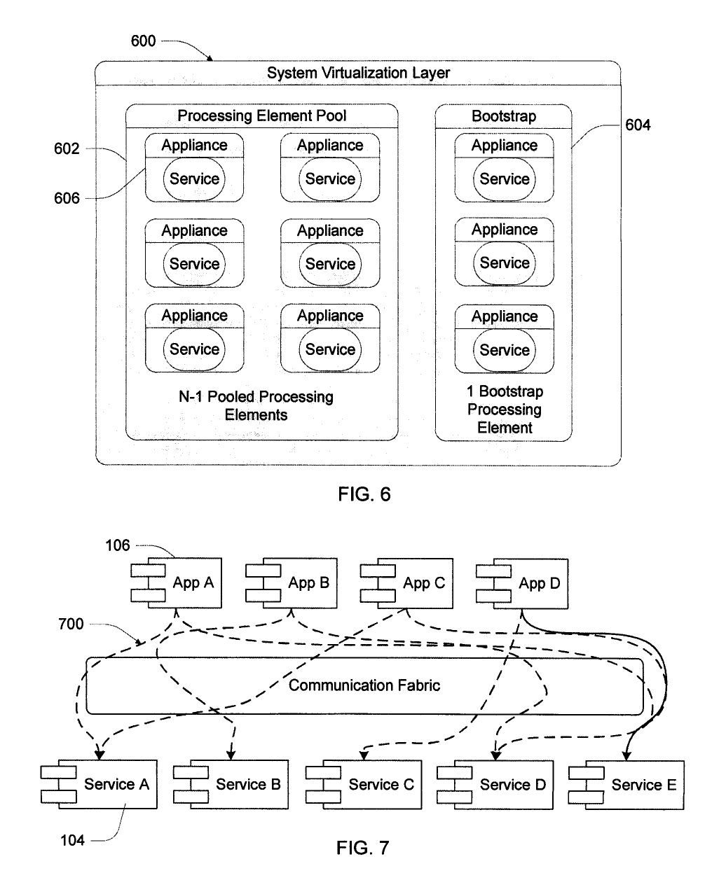

The virtualization layer 600 illustrated in FIG. 6 treats the collection of processing elements comprising a cloudbank 304 as a pool of resources to be managed in a shared fashion. The system virtualization layer is illustrated with a processing element pool 602 and a bootstrap processing element 604.

In a preferred embodiment, services and applications are packaged as appliances 606. An appliance 606 is a virtual machine image that completely contains the software components that realize a service or application. The ideal appliance 606 is one that can be cloned in a simple, regular and automated manner, allowing multiple instances of the appliance 606 to be instantiated in order to elastically meet the demands of the workload.

Appliances 606 will typically be associated with an environment that has common access control and scheduling policies. Typical environments are “production”, “staging”, “system test”, and “development”. Development personnel may have “free reign” to access resources in the development environment, while only select production support personnel may have access to resources in the production environment. When multiple environments are hosted on the same hardware, the production environment has the highest scheduling priority to access the resources, while the development environment might have the lowest scheduling priority to accessing resources. In IaaS, the system virtualization layer 204 can support multiple environments within the same resource pool.

The system virtualization layer 204 typically provides features that improve availability and maintainability of the underlying hardware, such as the capability to move a running virtual machine from one physical host to another within a cluster of physical hosts to, for example, facilitate maintenance of a physical host; the capability to move a running virtual machine from one storage device to another to, for example, facilitate maintenance of a storage device; automatic load balancing of an aggregate workload across a cluster of physical hosts; and the capability to automatically restart a virtual machine on another physical host in a cluster in the event of a hardware failure.

Storage virtualization is provided by either system virtualization software or by software resident on the network attached shared storage element. In the first case, many virtualization layers expose the notion of a “virtual disk”, frequently in the form of a file (or set of files) which appear to a guest operating system as a direct attached storage device. The second case is seen, for example, when a logical device is exposed as by Network File System (NFS) or Common Internet File System (CIFS) server.

Network virtualization is provided by either system virtualization software or by software resident on the attached network element. In the first case, many virtualization systems utilize the notion of a “virtual network device”, frequently in the form of a virtual NIC (Network Interface Card) or virtual switching system which appear to a guest operating system as a direct attached network device. The second case is seen, for example, when a logical device is exposed as a virtual partition of a physical Network Element via software configuration.

### Service Container Layer

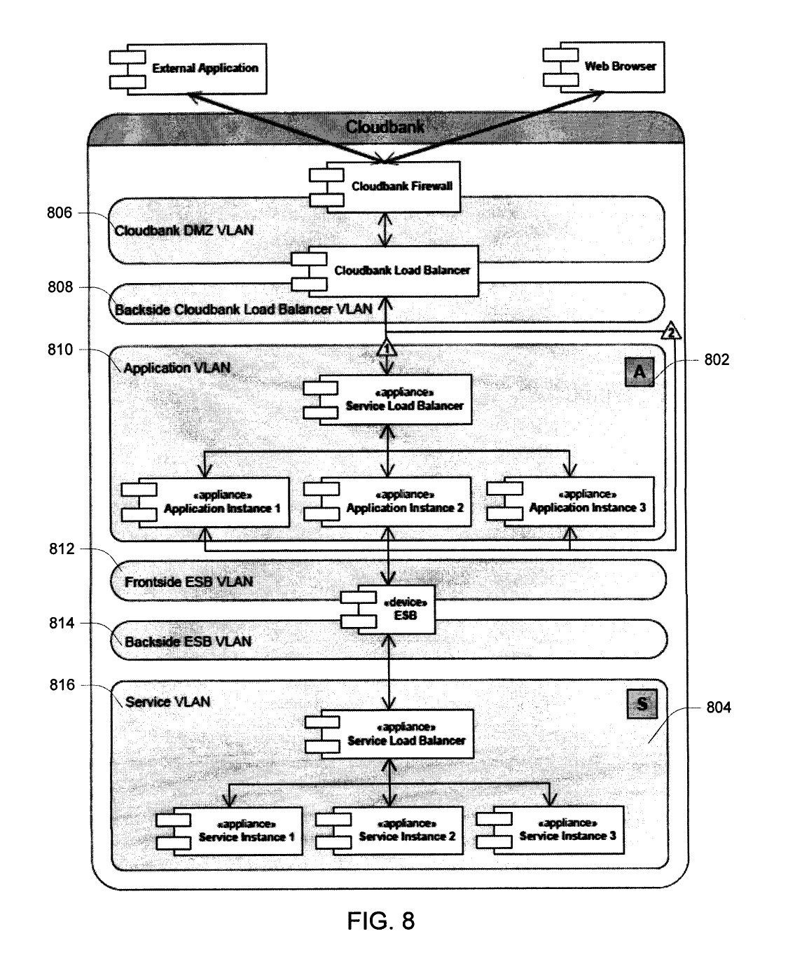

FIG. 7 illustrates the IaaS communication fabric 700. A cloudbank 304 hosts a suite of virtual appliances 606 that implement an ecosystem of applications 106 and services 104. For the purposes of this specification, an application 106 is a software component that is accessed “directly” from “outside” of the cloud, often by a user. A typical example of an application 106 is a web site that is accessed “directly” from a browser. In contrast, a service 104 is a software component that is typically invoked by applications 106, themselves often resident within the IaaS cloud. Services 104 are not accessible directly, but only by accessing the IaaS communication fabric 700. The communication fabric 700 provides a common place for expressing policies and monitoring and managing services. The term “communication fabric” may be synonymous with “ESB” and in this document we use the terms interchangeably.

When an application, whether external or internal to the IaaS cloud, invokes a service 104 it does so by sending the request to the communication fabric which proxies the request to a backend service as in FIG. 7. Applications 106 are public and services 104 are private. Both services 104 and applications 106 are realized by a collection of virtual appliances 606 behind an appliance load balancer. This collection of virtual appliances 606 and load balancer (which may be software load balancer realized by another virtual appliance 606) is called an appliance zone (or simply zone in contexts where there is no ambiguity) and it should be associated, one to one, with a virtual LAN. Note that the appliance zone must be able to span all the cloudlets 306 in a cloudbank 304; hence, a VLAN is a cloudbank-wide 304 resource. At the “front” of the cloudbank 304 is the cloudbank load balancer that is responsible for directing traffic to application zones or the ESB, as appropriate.

FIG. 8 depicts the logical organization of the cloudbanks 304 virtual appliances and load balancing components to handle traffic for applications 106 (labeled by route 1 on the figure) and services 104 (labeled by route 2 on the figure). The box labeled A 802 represents an application zone, while the box labeled S 804 represents a service zone. Also shown are examples of management VLANS that are also found in the infrastructure, including cloudbank DMZ VLAN 806, backside cloudbank load balancer VLAN 808, Application VLAN 810, frontside ESB VLAN 812, backside VLAN 816 and service VLAN 816.

Thus far, it has been a challenge to get such a system up and running. What is required is an automated system and method for provisioning such cloud components on demand. The automated and elastic provisioning provided in this disclosure provides a solution to this problem and offers other advantages over the prior art.

### Automated and Elastic Provisioning

An important feature of a preferred embodiment of an infrastructure-as-a-service system and method is the support for automated and elastic provisioning, which enables significantly improved IT efficiencies in managing the infrastructure. Also known as “fast provisioning,” automated and elastic provisioning greatly improves the time required to set up and productionize computing infrastructure. Automated provisioning is the use of software processes to automate the creation and configuration of zones and “insertion” and “removal” of a container into the cloud. Elastic provisioning is the use of software processes to automate the addition or removal of virtual appliances within a zone in response to the demands being placed upon the system.

Some of the resources that an automated provisioning system and method manage include:
1. a catalog of virtual appliances,
2. an inventory of network identifiers: MAC addresses, IP addresses and hostnames
3. network router and ESB device configurations

The naming and identification conventions that are adopted are preferably “friendly” to automation. Within the appliance zone, each virtual appliance may be allocated a unique IP address. The IP address allocated to a virtual machine must remain the same, regardless of where the virtualization layer places the virtual appliance within the cloudbank. The zone exposes the IP address of the appliance load balancer as the external IP address of the zone's application or service to its clients. For service zones, the “client” is always the ESB. Although not required by IEEE's 802.1Q standard (IEEE, 2006), it is expected that each VLAN is mapped to a unique IP subnet. Therefore, like VLANs, IP subnets are cloudbank-wide resources. IP addresses for a cloud-bank are managed by a cloudbank-wide DHCP server to which DHCP multicast traffic is routed by a DHCP proxy in the cloudbank router. The DHCP service is responsible for managing the allocation of IP addresses within the cloudbank.

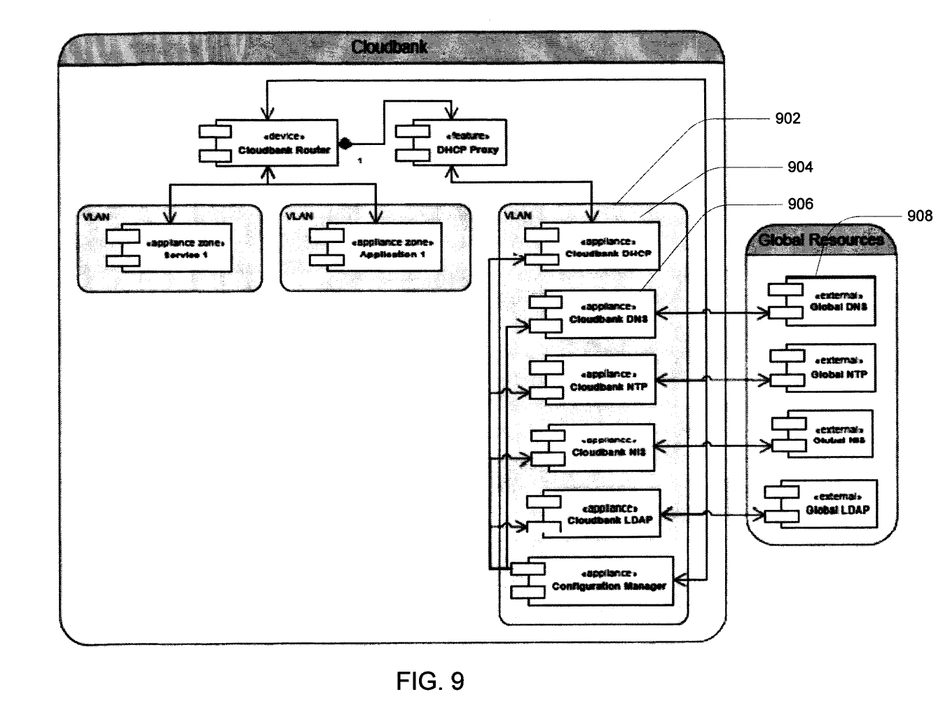

Referring to FIG. 9, the VLAN at the right of the figure is called the cloudbank management VLAN 902 and it contains a number of appliances that provide capabilities for the Service Container Layer 206. The Cloudbank DHCP appliance 904 implementing the DHCP service is shown in the figure.

Sometimes it is necessary for an appliance running in one cloudbank 304 to be able to communicate directly to its peer appliances running in other cloudbanks (appliances implementing DHTs or internal message buses need to do this). Therefore, the IP allocation scheme probably cannot impose the same set of private IP addresses to each cloudbank 304, but instead must allow some form of “template” to be applied to each cloudbank 304. Each cloudbank would apply a common allocation “pattern” that results in unique addresses (within the environment infrastructure) for each cloudbank 304.

### Host and Domain Name Management

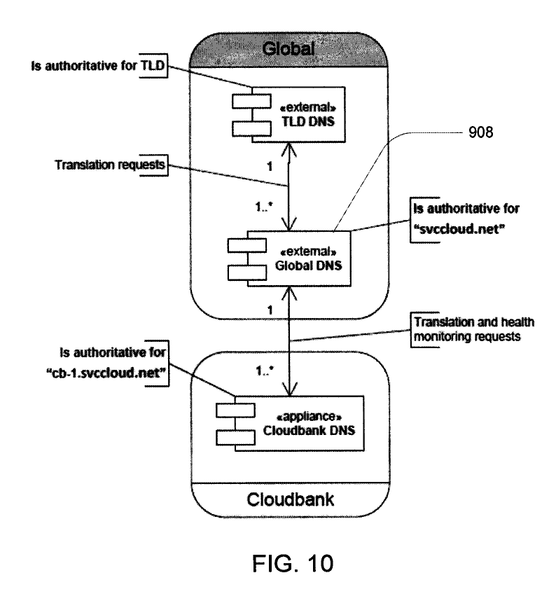

FIG. 9 also shows a cloudbank DNS appliance 906 in the management VLAN. It performs all name resolutions within the cloudbank 304. It is the authoritative DNS server for the cloudbank's 304 domain. A Global DNS 908, also illustrated in FIG. 10, exists outside the IaaS cloud. It is the authoritative DNS server for the global IaaS domain namespace (“svccloud.net”). The Global DNS server 908 should be capable of performing “location aware” ranking of translation responses, ordering the response list according to the network distance or geographical proximity of the resource (a cloudbank 304) to the client, with those resources residing closer to the client being returned before resources that are farther from the client. The Global DNS 908 should also be able to filter its response based upon the availability of the resource as determined by a periodic health check of the cloudbank 304 resources.

Cloudbank DNS servers 906 must have secondary instances for high availability. Furthermore since the primary cloudbank DNS 906 runs inside a virtualization container that refers to names that the cloudbank DNS 906 is responsible for translating, failures may not be correctable (“chicken and egg” problems) without a reliable secondary. Therefore, a cloudbank DNS 906 server must have secondary instances and at least two secondary instances must reside outside the cloudbank 304. A recommended configuration is to run one secondary in another cloudbank 304 and a second in a highly available DNS host altogether external to the cloud.

Uniform naming of resources is important to ease automated and elastic provisioning. FIG. 10 illustrates an exemplary configuration of DNS servers for DNS name resolution. An exemplary naming convention is described in Table 1, below.

TABLE 1
A DNS Naming convention

| DNS Name | Description |
|---|---|
| svccloud.net | Domain name of the cloud as a whole. The global |
| | DNS server is responsible for performing name |
| | resolution for this domain. |
| cb-1.svccloud.net | Domain name of cloudbank one. The cloudbank |
| | DNS is responsible for performing name resolution |
| | for this domain. Each cloudbank is assigned a |
| | decimal identifier that uniquely identifies it within the |
| | cloud. |
| z-1.cb-1.svccloud.net | Domain name of the appliance zone within one |
| | cloudbank one. The cloudbank DNS is responsible |
| | for performing name resolution for this domain. |
| | Each zone is assigned a decimal identifier that |
| | uniquely identifies it within the cloudbank in which |
| | it resides. |
| a-1.z-1.cb-1.svccloud.net | Host name of appliance one within appliance zone |
| | one of cloudbank one. The cloudbank DNS is |
| | responsible for resolving this name. |
| | Each appliance is assigned a decimal identifier that |
| | uniquely identifies it within the appliance zone in |
| | which it resides. |
| {resource}.svccloud.net | Global name of a resource within the cloud. These |
| | names are resolved by the global DNS to a list of |
| | cloudlet specific resource names (A records). In a |
| | preferred embodiment, the global DNS can order |
| | the returned names by network distance or |
| | geographical proximity of the client to a cloudbank. |
| | Additionally, it is desirable for the Global DNS |
| | server to be able to “health check” the cloudbank |
| | names to avoid sending a client an unavailable endpoint. |
| esb.svccloud.net | Global host name of an ESB resource within the |
| | cloud. This name is resolved by the global DNS to |
| | a list of cloudbank specific ESB resource addresses |
| app-foo.svccloud.net | Global host name of an application called “app- |
| | foo” within the cloud. This name is resolved by the |
| | global DNS to a list of cloudlet specific “app-foo” |
| | resource addresses |
| service-bar.svccloud.net | Global host name of a service called “service-bar” |
| | within the cloud. This name is resolved by the |
| | global DNS to a list of cloudlet specific “service- |
| | bar” resource addresses. |
| {resource}.cb-1.svccloud.net | Host name of a resource within cloudbank one. |
| | These names are resolved by the cloudbank DNS to |
| | a list of addresses of the resource (usually the load |
| | balancers fronting the resource). |
| esb.cb-1.svccloud.net | Host name of an ESB resource within cloudbank |
| | one. This name is resolved by the cloudbank DNS |
| | to a list of cloudbank specific addresses for the |
| | load-balancers fronting the ESB devices. |
| app-foo.cb-1.svccloud.net | Host name of an application called “app-foo” |
| | within cloudbank one. This name is resolved by |
| | the cloudbank DNS to a list of cloudbank specific |
| | addresses for the load-balancers fronting the |
| | application appliances. |
| service-bar.cb-1.svccloud.net | Host name of a service within cloudbank one. This |
| | name is resolved by the cloudbank DNS to a list of |
| | cloudbank specific addresses for the load-balancers |
| | fronting the ESB devices. |

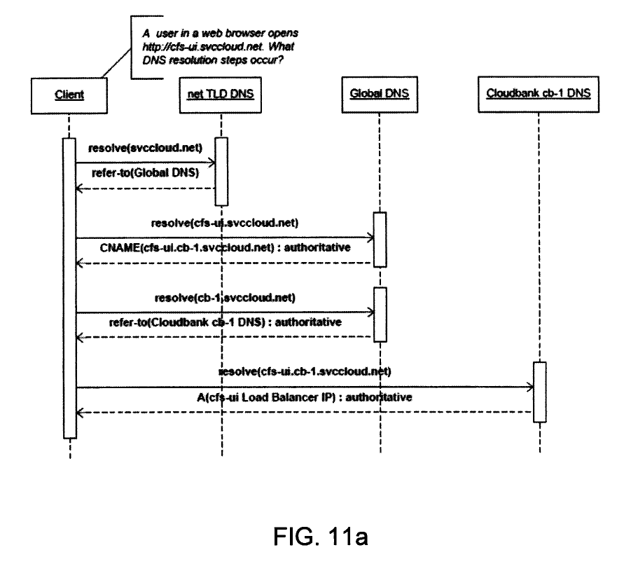

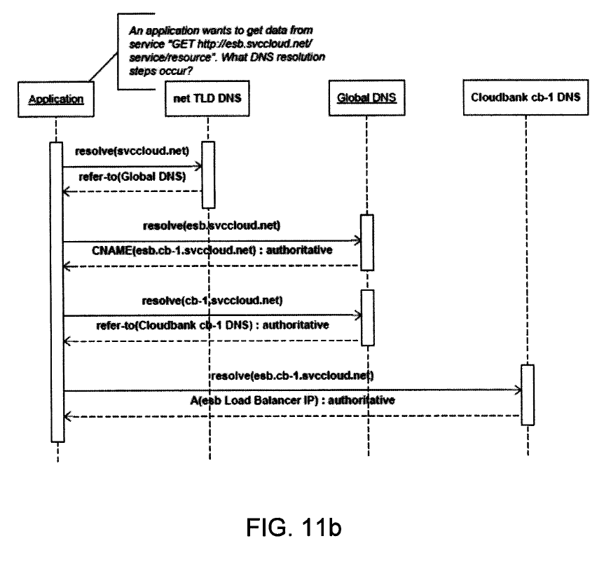

FIGS. 11a and 11b are sequence diagrams illustrating an example of DNS resolution of a global application (FIG. 11a) and a service call via ESB (FIG. 11b).

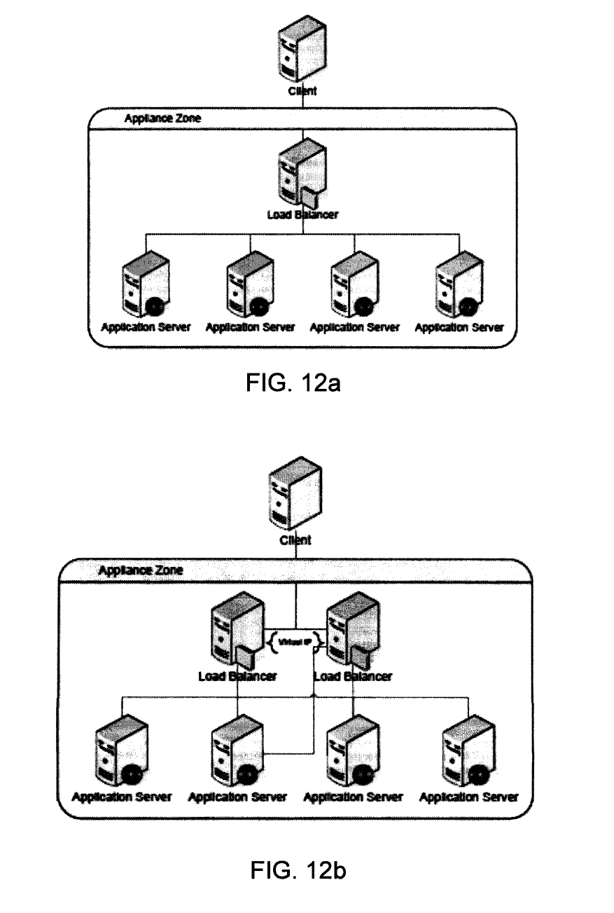

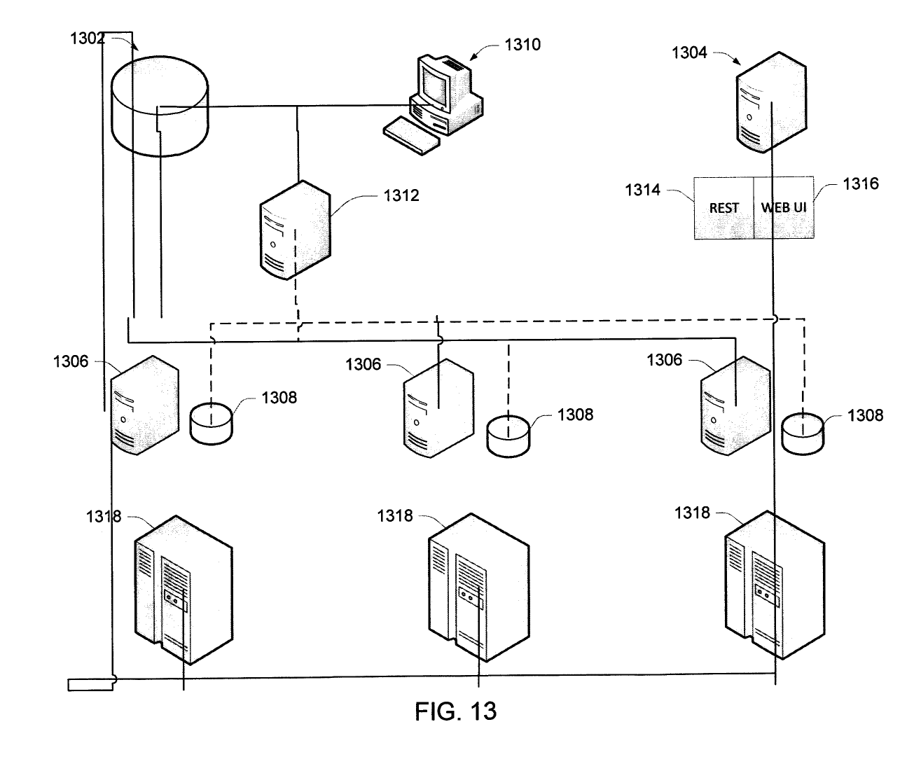

Load balancing may be provided at any level, particularly at the cloudbank and appliance zone levels. Appliance zone load balancers are virtual appliances that perform a load balancing function on behalf of other virtual appliances (typically web servers) running on the same zone subnet. The zone load-balancer is an optional component of the zone. The standard load-balancing model for an appliance zone is a single appliance configuration as shown in FIG. 12a. A multiple load-balancing model is shown in FIG. 12b.

### Fast Provisioning

In an embodiment of Infrastructure-as-a-Service, users of infrastructure units, such as web servers, databases, etc. may be allowed to rapidly deploy the required hardware and software without intervention from system administrators. This will greatly decrease the time it takes to put a unit into service, and greatly reduce the cost of doing so. In a preferred embodiment, a set of rules governs users' access to a fast provisioning system. Approved users may access the provisioning system with a user name and password.

### Provisioning System Technology Stack

Choosing a full technology stack on which to build a provisioning service is not an easy task. The effort may require several iterations using multiple programming languages and technologies. An exemplary technology stack is listed in Table 2 along with notes regarding features that make the technology a good choice for fast provisioning.

TABLE 2
Exemplary Fast Provisioning Technology Stack

| Type | Example Technology | Notes/Features |
|---|---|---|
| API | VSphere API | SOAP API with complex |
| | | bindings (Java and .NET); vijava |
| Language | Java | The natural choice for interacting |
| | | with viJava; |
| Language | Python | Interpreted language; large and |
| | | comprehensive standard library; |
| | | supports multiple programming |
| | | paradigms; features full dynamic |
| | | type system and automatic |
| | | memory management; java port |
| | | is “Jython” |
| Framework | Django | Development framework follows |
| | | model-template-view |
| | | architectural pattern and |
| | | emphasizes reusability and |
| | | “pluggability” of components, |
| | | rapid development, and the |
| | | principle of DRY (don't repeat |
| | | yourself) |
| | Piston - REST API | Piston |
| | Ajax | Dajax is a powerful tool to easily |
| | | and quickly develop |
| | | asynchronous presentation logic |
| | | in web applications using Python. |
| | | Supports the most popular JS |
| | | frameworks. Using dajaxice |
| | | communication core, dajax |
| | | implements an abstraction layer |
| | | between the presentation logic |
| | | managed with JS and the Python |
| | | business logic. DOM structure |
| | | modifiable directly from Python |
| | Javascript | Prototype Javascript framework |
| | | and scriptaculous |
| Database | MySQL | Popular, easy installation and |
| | | maintenance, free. |
| Web Server | Tomcat 5 | Jython runs on JVM |

FIG. 13 illustrates an exemplary component architectural diagram for an embodiment of a fast provisioning system. These components may be distributed across multiple data centers, possibly in disparate locations. A GIT repository supporting a fast provisioning system is typically broken out into two separate repositories. One 1302 contains all of the chef recipes, the other contains the code and scripts for the provisioning system itself 1304. The chef repository 1302 refers to a “book of truth” containing all the recipes used to build out and configure systems deployed using the fast provisioning system. Developers use this repository for code check in/checkout. It is a master repository used for merging changes into the branch master and uploading to chef servers 1306 and database 1308. The fast provisioning repository contains all the scripts written to support fast provisioning.

Each virtual data center (which may be comprised of a data center and a virtualization platform client) 1318 has its own chef server 1306. As part of the deploy process, clients (VMs) in each virtual data center 1318 register with the appropriate chef server. A chef server 1306 is further used to perform initial system configuration (package installation, file placement, configuration and repeatable administrative tasks) as well as for code updates and deployment. Access to the chef servers 1306 is typically controlled through a distributed name service and may be limited to engineers. A tool, such as VMWARE™ studio 1310 for example, may be used as the image creation mechanism. It is used for creating and maintaining versioned “gold master” Open Virtualization Format (OVF) images. Further customization of the guests is performed through a set of firstboot scripts, also contained within machine profiles in the studio.

A continuous integration server 1312 is used to distribute the OVF images to repositories in each virtual data center 1318. This server may also be used for a variety of other tasks, including building custom RPM Package Manager (RPM) packages, log management on the data powers and other event triggered tasks. Most importantly, it is used to automate the distribution of chef recipes on repository check-in.

The virtual data center 1318 localized package repositories 1308 contain copies of all of the OVF gold master images, as well as copies of all of the custom built RPM packages. These machines are standard guests with large NFS backed persistent storage back-ends to hold the data. Support for local repositories is installed through a chef script during initial configuration.

A RESTful domain name system (DNS) service 1314 may be used to handle all of the DNS registrations during the machine deployment process. Once a machine name and IP has been assigned by the fast provisioning service, an automated REST call is performed to do the registration.

The provisioning service communicates with each virtual data center server via a soap XML interface and communicates with Chef Servers via a REST interface 1314. The provisioning service provides a simple RESTful interface and Web UI for internal provisioning.

The Fast Provisioning System integrates the various underlying technologies and offers additional benefits, such as: Integration with DNS registration; integration with OPScode Chef for automated configuration of services; stores VM creation details for rapid deployment in the event of loss; provides finer privilege control; can decide exactly what a user sees and can do; integration with other disparate systems, like storage, monitoring and asset management; provides a simple REST interface for integration of the provisioning system into other tools and software; automatically uploads the appropriate OS image to the system during deployment with no extra steps.

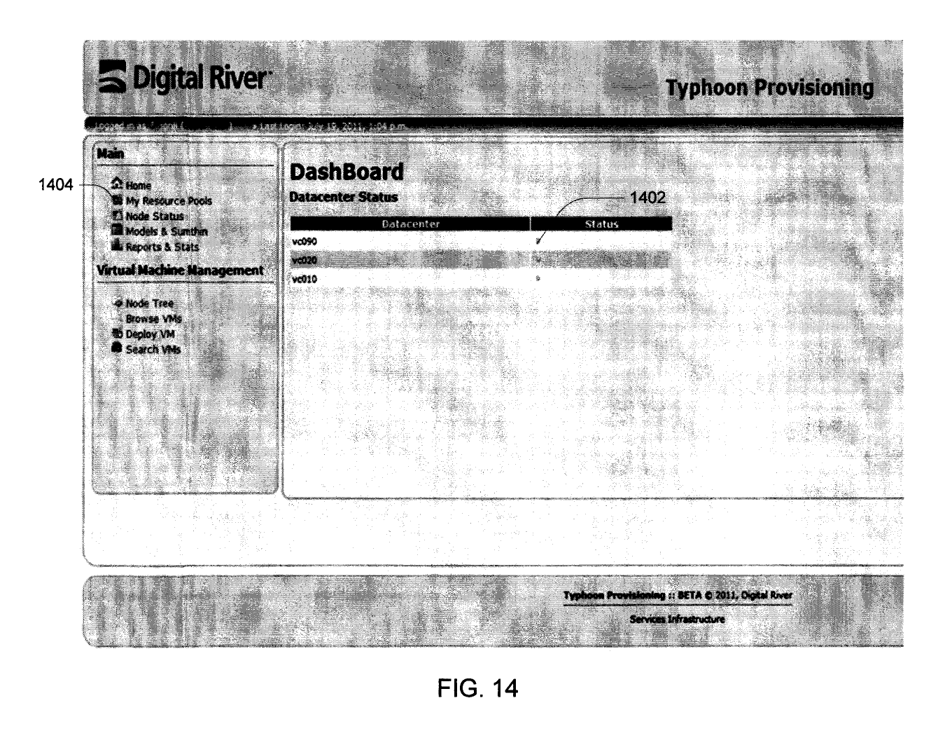

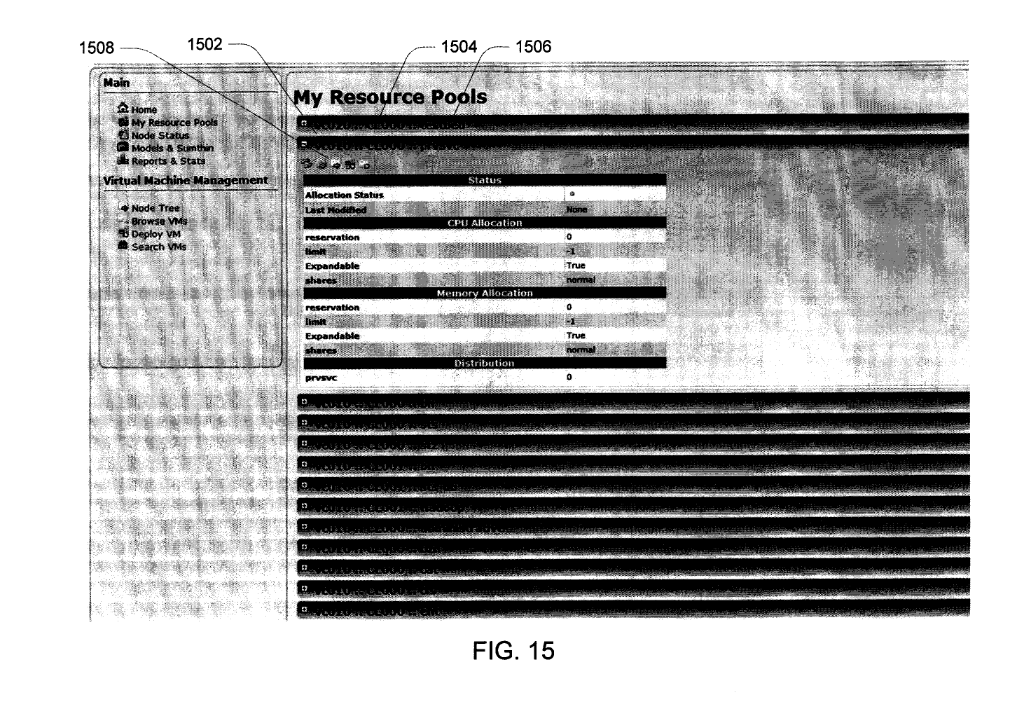

A preferred embodiment of a fast provisioning system and method includes a user interface and a number of modules, each module stored on computer-readable media and containing program code which when executed cause the system to perform the steps necessary to perform functions toward creating the virtual environment. The code modules may be integrated with various tools and systems for the creation and management of virtual resources. A graphical user interface (GUI) steps the user through the process of creating virtual resources. A preferred embodiment of a provisioning service is accessed with a user name and password provided to approved users. FIGS. 14-30 illustrate the provisioning process using a Fast Provisioning system and method. FIG. 14 illustrates a home screen that may include a dashboard showing datacenter status for all of the data centers for which the user has access. A status light 1402 may use an indicator color to convey the datacenter status to the user. Selecting “My Resource Pools” 1404 under the Main menu redirects the user to the My Resource Pools screen (FIG. 15), which allows the user to view status, CPU allocation, memory allocation and distribution details for each of the user's resources (i.e. server systems). The user presented with the resource pools in FIG. 15 has a number of resources 1506 in virtual centers vc020 and vc010 1502, on cloudlets CL000 and CL001 1504. Selecting the vc010::CL000::prvsvc resource provides the details for that resource. Icons below the resource name 1508 provide utilities that allow the user to refresh the cache to view changes in the display, view settings and resource pool details, and perform virtual machine management functions such as create and deploy new resources. An advantage of deploying a resource from this screen is that the resource will be deployed to the specific resource pool selected.

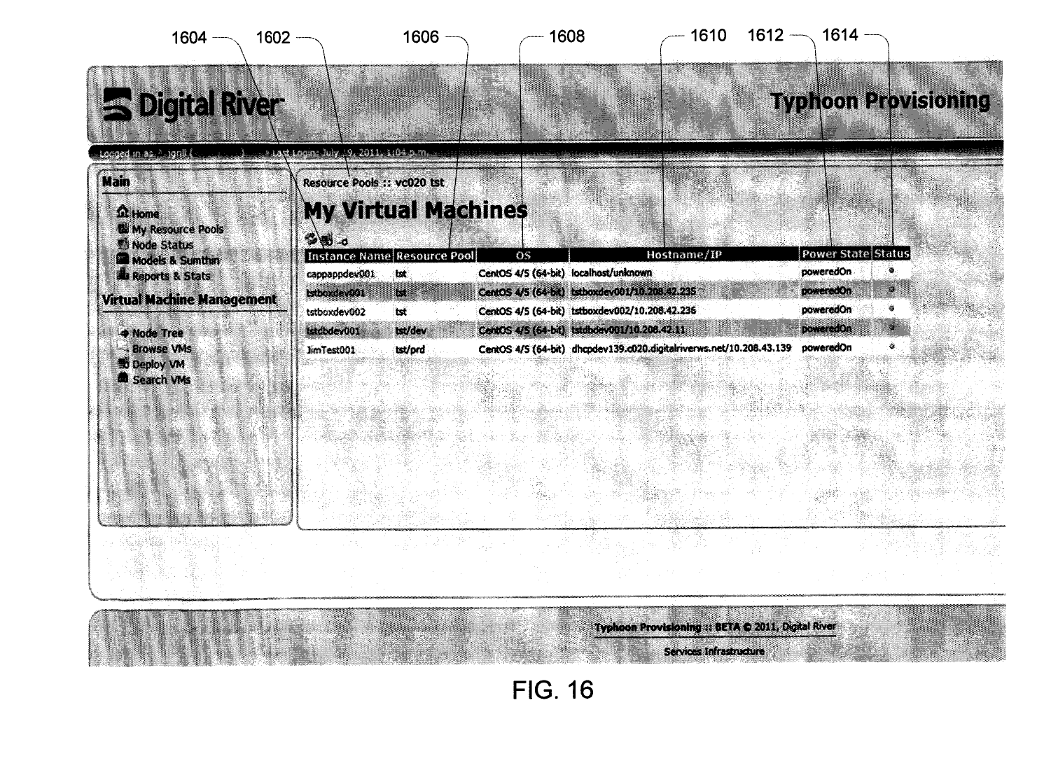

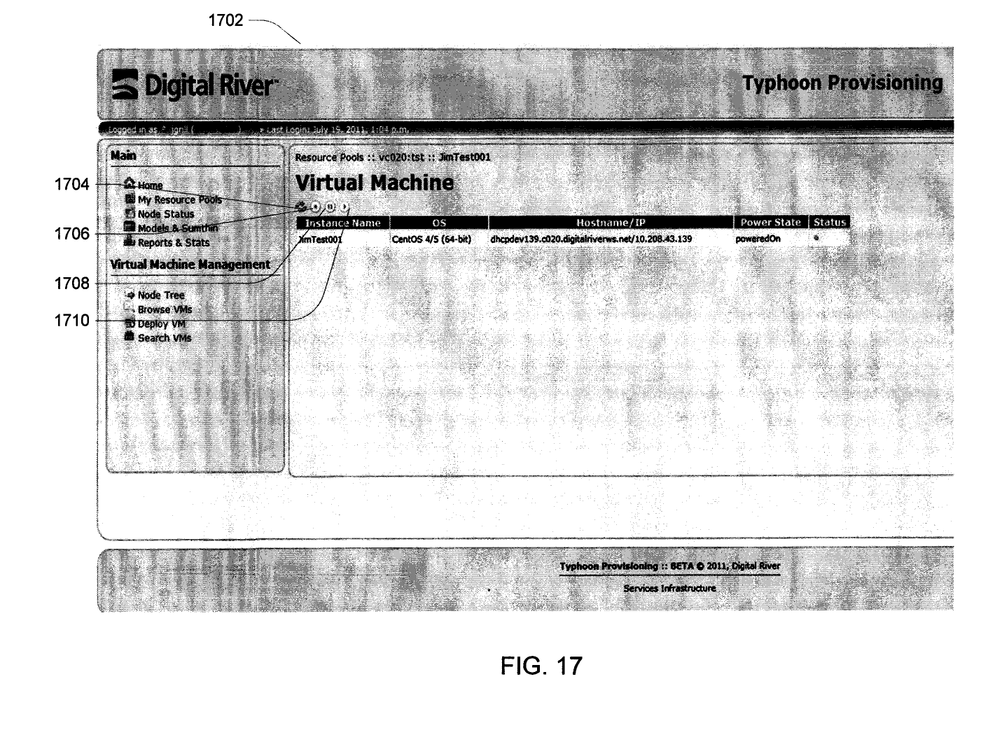

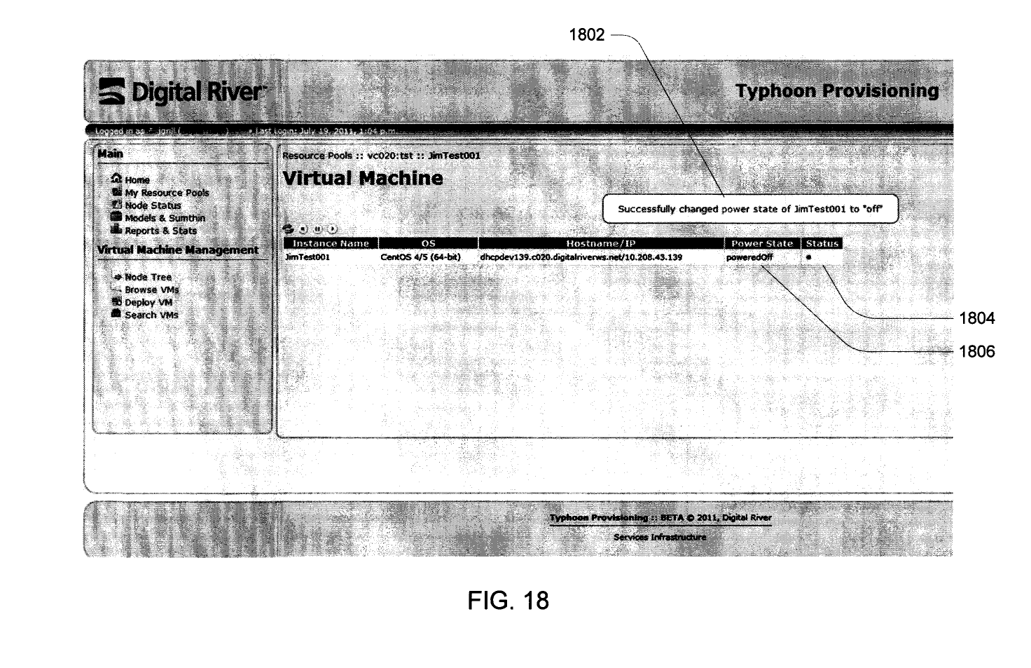

Referring now to FIG. 16, Drilling down on the resource pools 1602 in the virtual center allows the user to view all Virtual Machines assigned to the user, including the instance name 1604, resource pool 1606, operating system information 1608, hostname/IP address 1610, power state 1612 and status 1614. Selecting a particular virtual machine generates a screen specific to the selected virtual machine (FIG. 17 1702) and includes icons that allow the user to refresh the view 1704, power down 1706, suspend 1708, or power up 1710 the particular instance. When the user attempts to change the power state of the resource, the user is notified (FIG. 18) with a success or failure message 1802. The power state 1804 and status 1806 values change accordingly. The user may also view resources by selecting the node tree from the Virtual Machine Management menu on the left side of the screen (FIG. 18), and drill down to the virtual resource details from this screen.

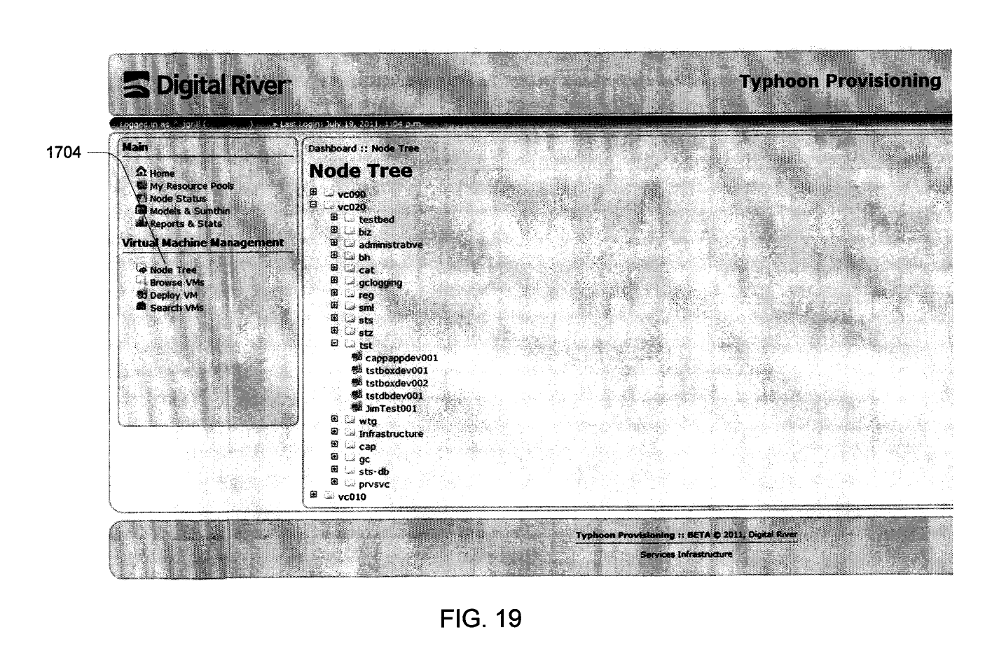

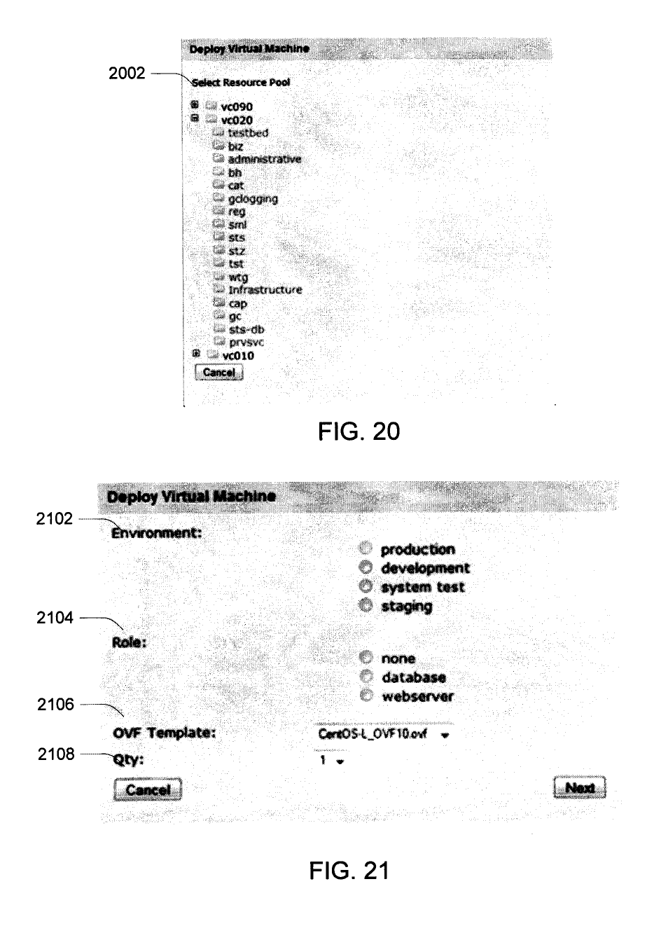

By selecting “Deploy VM” from the Virtual Machine Management menu, the user may deploy a resource into a particular pool. A “Deploy Virtual Machine” popup window (FIG. 19) allows the user to select the resource pool. This window may overlay the node tree view of FIG. 18. Selecting a pool may generate the “My Virtual Machines” screen (FIG. 20) from which the user may select a “deploy” icon 2002 to indicate from which resource pool to deploy. Various popup windows may offer options to the user.

Referring now to FIG. 21, the user is initially asked to select an environment and role for the new resource. A deployment life cycle may consist of a series of deployments for QA purposes, such as deploying to development, then test, then staging, and finally to production, depending on the requirements of the user. Any such life cycle may be accommodated by allowing the user to select the environment 2102 to which the resource will deploy. A machine role is also selected 2104. The role indicates the type of resource that is being deployed, such as database or web server. Roles allow the system to provide standard code files, or recipes, for configuring a particular type of server. The role selected will determine the options that are subsequently presented to the user. Choosing “no role” means the user must select from a variety of options for all components, rather than taking advantage of the prepackaged configurations. The user selects the OVF template for installation 2106, and the quantity of such resources required 2108.

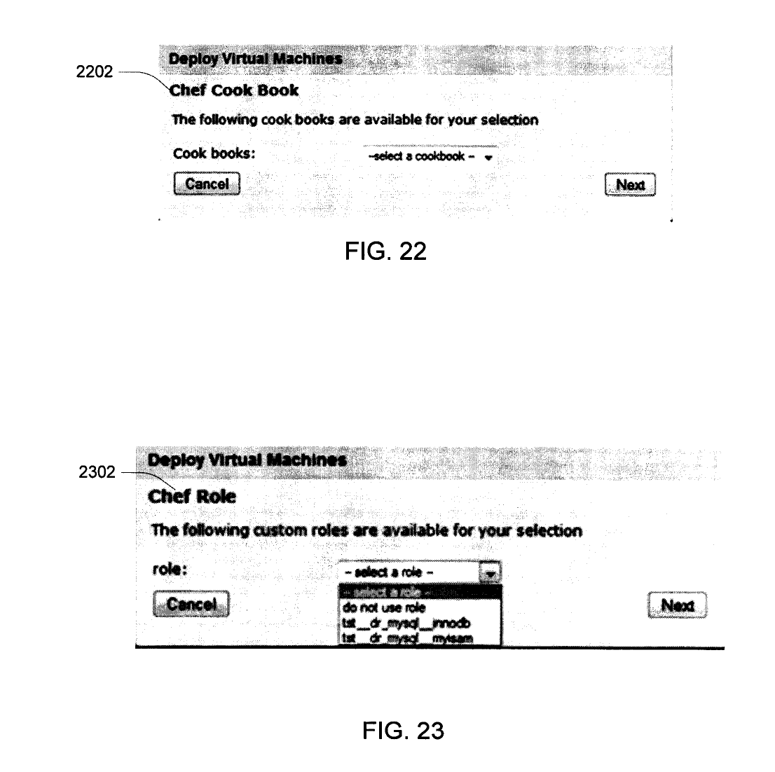

Next, the user selects a Chef Cook Book 2202 from the options available for the designated role (FIG. 22). The terms “chef,” “cook book” and “recipes” are used here to describe the roles, repositories and instructions, respectively, for creating the required resources. This terms are meant to be merely descriptive and not limiting in any way. As was discussed above, cook books hold “recipes” for creating the virtual machine. They consist of code modules that configure the system to company standards and requirements. The cook book may contain code for any type of desired feature. An exemplary cook book may be a “mysql” cook book which is offered as an option when a database role is selected along with others.

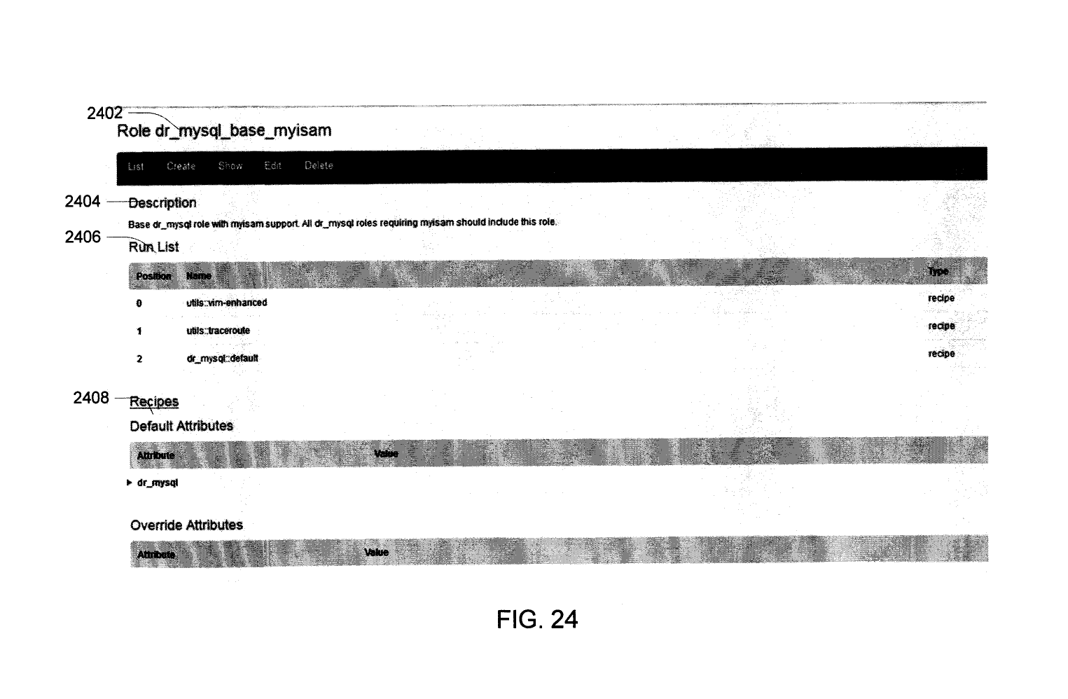

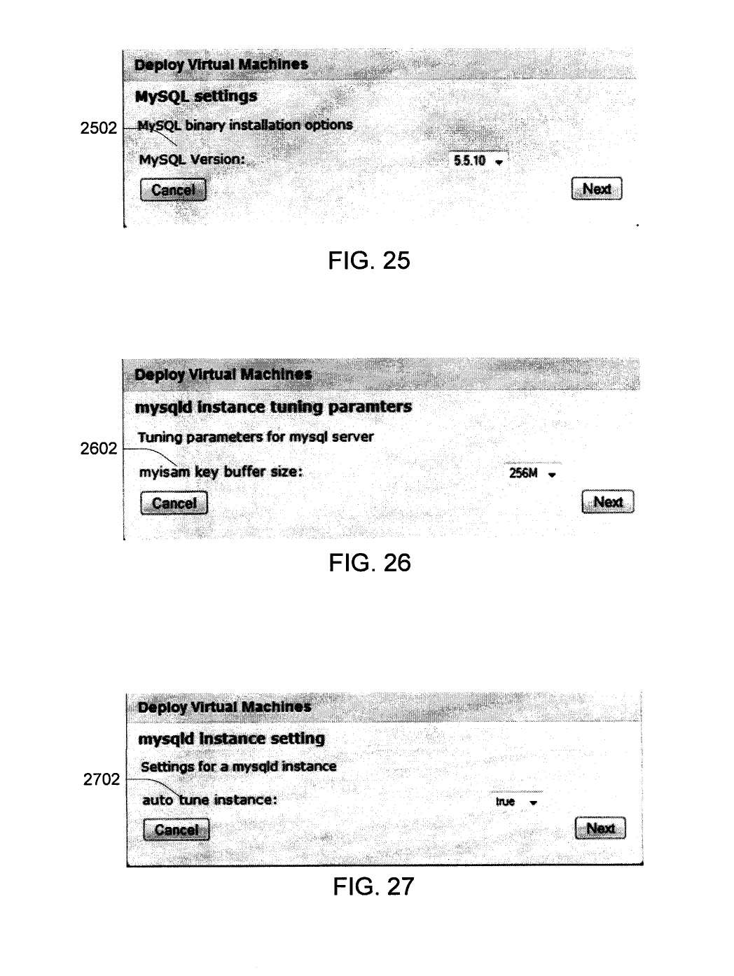

Next, as is illustrated in FIG. 23, the user chooses a Chef Role 2302 from those available for the selected resource. As with roles discussed above, each role further identifies the code and features that go into configuring a specific resource, and drive the options that are subsequently presented to the user. FIG. 24 is a screen shot of the recipes associated with an exemplary role. Such a screen in a preferred embodiment of a role 2402 provides a description of the recipes 2404 included in the role along with a run list 2406, and default or other required attributes 2408. In FIGS. 25, 26 and 27, the user is presented with options for settings used to deploy virtual machines, such as which of the company's supported version of the software 2502 is desired (FIG. 25), application tuning requirements 2602 (FIG. 26) and, if so, options for tuning parameters 2702 (FIG. 27).

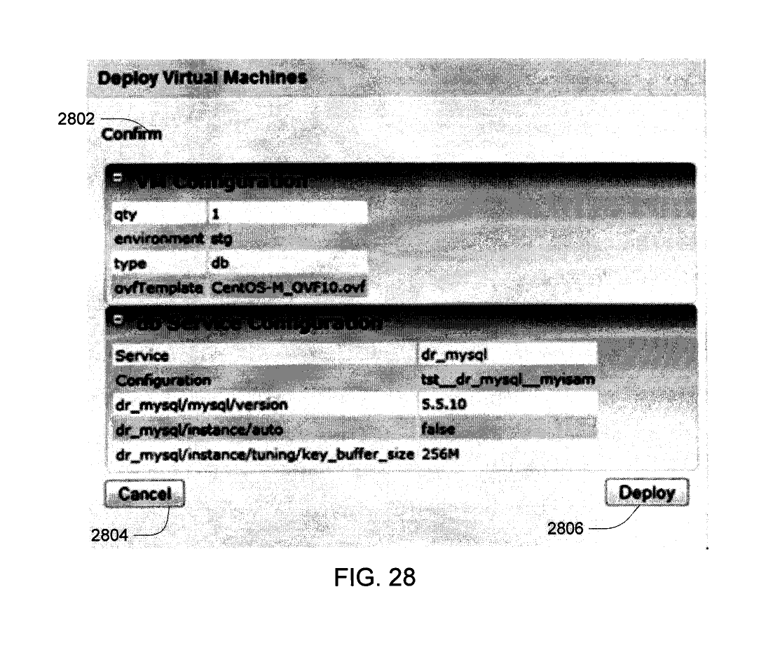

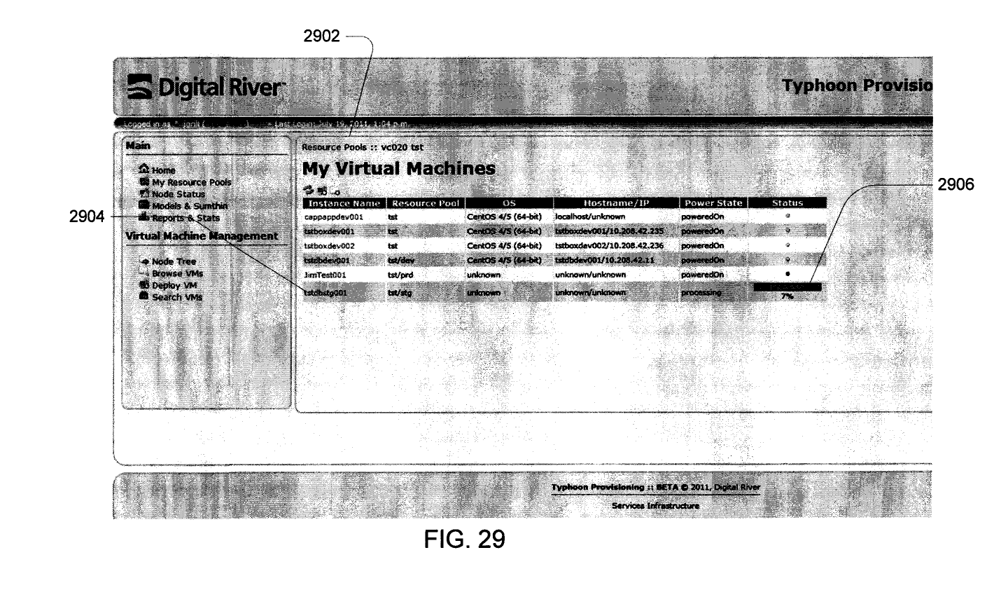

When all of the options and features for a resource role have been selected, the user may be presented with a confirmation popup window 2802, as shown in FIG. 28. All of the selected parameters and values are presented to the user so that they may be confirmed before deploying the instance. The user may cancel the configuration 2804 or deploy the virtual machine as configured 2806. When the user clicks the “Deploy” button 2806, a screen may be displayed 2902 showing all of the virtual machines associated with the user (FIG. 29). The deploying instance 2904 is included on the list of resources, along with a processing status bar 2906. A status message is presented to the user when deployment has completed or has been aborted for some reason.

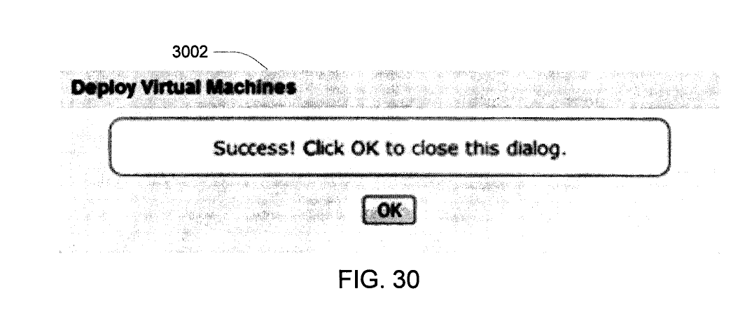

Back-end processing includes assigning an IP address and host name, and registering these identifiers with the DNS; creating the virtual space for the server and installing the requested software. The user is presented with a confirmation that the resource creation process is completed and fully deployed (FIG. 30).

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular physical components, software development tools and code and infrastructure management software may vary depending on the particular system design, while maintaining substantially the same features and functionality and without departing from the scope and spirit of the present invention.

What is claimed is:

1. A cloud-based infrastructure-as-a-service hardware platform physical element, comprising:
a processing component supplying the computational capacity for a platform element, comprising one or more processing elements, memory and I/O subsystems;
a storage component utilizing commodity disk drives and comprised of one or more physical storage devices; and
a network component providing a high speed connection among processing elements and the processing component to storage components.

2. A cloud-based infrastructure-as-a-service hardware platform, comprising:
a physical layer component supplying the computational capacity for a platform element, comprising one or more processing elements, memory and I/O subsystems and high speed network devices;
a virtualization layer component comprising a system virtualization element, a storage virtualization element, and a network virtualization element; and
a service container level comprising a collection of one or more virtual appliances containing applications and services and a communication fabric accessing services.

3. The cloud-based infrastructure-as-a-service hardware platform of claim 3 where the processing elements in the physical layer are pooled to increase the capacity of the resources being virtualized.

4. A cloud-based infrastructure-as-a-Service hardware platform system, comprising one or more of the units in claim 3, interconnected via the internet or an intranet using standard networking protocols.

5. The cloud-based infrastructure-as-a-service hardware platform of claim 3 where the processing elements used by the one or more virtual appliances are pooled.

6. The cloud-based infrastructure-as-a-service hardware platform of claim 3 where the storage used by the one or more virtual appliances is clustered.

7. The cloud-based infrastructure-as-a-service hardware platform of claim 3 where network resources teamed.
The cloud-based system of claim 5 with an intelligent DNS system to (i) minimize the network distance between a client and a cloudbank resident resource and (ii) to avoid giving a client the address of a “dead” resource.
Applications are provided in the form of an appliance containing an image of an operating system.

5. A fast provisioning system for creating an infrastructure-as-a-service virtual computing platform, comprising:
a graphical user interface for creating computing resources;
an image creation mechanism a resource creation module [chef server with roles, cookbooks and recipes for creating particular types of resources (OVF image?)]; and
a service container module comprising a collection of one or more virtual appliances containing applications and services and a communication fabric accessing services.

8. A fast provisioning system for creating an infrastructure-as-a-service virtual computing platform, comprising:
a graphical user interface for creating computing resources;
a resource creation module that produces
a first prompt including a listing of one or more instruction sets for a virtual machine; and
a second prompt including a listing of one or more roles for a virtual machine, the resource creation module receiving responses from the first prompt and the second prompt and creating a virtual machine in response to the response to the first prompt and the response to the second prompt.

9. The fast provisioning system of claim 8 wherein the virtual machine created is provided with a domain name by a domain name provisioning module.

10. The fast provisioning system of claim 9 wherein the domain name provisioning module assigns a domain name to a virtual machine created by the resource creation module.

11. The fast provisioning system of claim 9 wherein the domain name provisioning module assigns a domain name automatically to a created virtual machine.

12. The fast provisioning system of claim 9 wherein the domain name provisioning module includes a domain name management tool to minimize the network distance between a client and a cloudbank resident resource.

13. The fast provisioning system of claim 9 wherein the domain name provisioning module includes a domain name management tool to prevent deployment of an address to a nonfunctioning resource.

14. The fast provisioning system of claim 9 wherein the resource creation module stores a number of combinations of roles and instruction sets preconfigured as virtual machines.

15. A method for fast provisioning of cloud based systems including:
prompting the selection of one or more instruction sets for a virtual machine from a first list;
receiving a selection from the first list;
prompting the selection of one or more roles for a virtual machine from a second list;
receiving a selection from the second list;
creating a resource in response to the selection from the first list and the selection of the second list; and
assigning a domain name to the resource.

16. The method of claim 15 wherein the method is carried out using processors that can be shared with other created resources.

17. The method of claim 15 wherein a plurality of resources are formulated, the plurality of resources sharing a processor.

18. The method of claim 15 wherein a plurality of resources are formulated, the plurality of resources sharing a storage device.

19. The method of claim 15 wherein a plurality of resources are formulated, the plurality of resources sharing a database.

20. A machine-readable medium that provides instructions that, when executed by a machine, cause the machine to perform operations comprising:
prompting the selection of one or more instruction sets for a virtual machine from a first list;
receiving a selection from the first list;
prompting the selection of one or more roles for a virtual machine from a second list;
receiving a selection from the second list;
creating a resource in response to the selection from the first list and the selection of the second list; and
assigning a domain name to the resource.
